(19) United States
(12) Patent Application Publication
(10) Pub. No.: US 2025/0184555 A1
(43) Pub. Date: Jun. 5, 2025

(54) METHOD AND APPARATUS FOR CREATING TARGET LIVE STREAM ROOM, ELECTRONIC DEVICE, AND STORAGE MEDIUM

(71) Applicant: Beijing Zitiao Network Technology Co., Ltd., Haidian District, Beijing (CN)

(72) Inventors: Jiayi Li, Beijing (CN); Guanghui Ren, Beijing (CN); Ying Song, Beijing (CN); Qiang Li, Beijing (CN); Yaxi Xu, Beijing (CN); Han Zhang, Beijing (CN); Bin Wang, Beijing (CN); Tiantian Zhang, Beijing (CN); Miao Wu, Beijing (CN)

(21) Appl. No.: 18/842,370

(22) PCT Filed: Feb. 22, 2023
(86) PCT No.: PCT/CN2023/077705

§ 371 Date: Aug. 28, 2024

(30) Foreign Application Priority Data
Feb. 28, 2022 (CN) 202210188334.0

(51) Int. Cl. H04N 21/266; H04N 21/2187; H04N 21/2347; H04N 21/258; H04N 21/431

(52) U.S. Cl. CPC H04N 21/266; H04N 21/2187; H04N 21/2347; H04N 21/25816; H04N 21/431

(57) ABSTRACT

Provided are a method and apparatus for creating a target live stream room, an electronic device, a storage medium, a computer program product and a computer program. The method includes: in response to a first input operation, displaying a first configuration page corresponding to a first streamer identifier; in response to a second input operation for the first configuration page, obtaining a live stream parameter, wherein the live stream parameter comprises a resource parameter; and transmitting a creation request to a server based on the live stream parameter, such that the server creates a target live stream room corresponding to the first streamer identifier.

### CROSS REFERENCE TO RELATED APPLICATIONS

This disclosure claims priority to Chinese Patent Application No. 202210188334.0, filed with the Chinese Patent Office on Feb. 28, 2022 and entitled “METHOD AND APPARATUS FOR CREATING TARGET LIVE STREAM ROOM, ELECTRONIC DEVICE, AND STORAGE MEDIUM”, which is incorporated herein by reference in its entirety.

### FIELD

Embodiments of the present disclosure relate to the field of Internet technologies, and in particular, to a method and an apparatus for creating a target live stream room, an electronic device, a storage medium, a computer program product, and a computer program.

### BACKGROUND

At present, with the rapid development of the live broadcast industry, more and more users watch live broadcasts and join the live broadcast industry, and the live broadcast becomes an emerging and important media channel. Meanwhile, with the rapid increase of the number of streamers, live broadcast contents provided to audiences from various types of live stream rooms of the live broadcast platform are becoming more and more abundant. Some large-scale activities, such as online concerts and online drama shows, are provided to audiences in a form of live stream room, so as to meet the demand of the audiences in viewing high-quality content.

### SUMMARY

Embodiments of the present disclosure provide a method and apparatus for creating a target live stream room, an electronic device, a storage medium, a computer program product and a computer program.

According to a first aspect, an embodiment of the present disclosure provides method for creating a target live stream room, which is applied to a client of a streamer, and the method includes: in response to a first input operation, displaying a first configuration page corresponding to a first streamer identifier; in response to a second input operation for the first configuration page, obtaining a live stream parameter, wherein the live stream parameter includes a resource parameter; and transmitting a creation request to a server based on the live stream parameter, such that the server creates a target live stream room corresponding to the first streamer identifier; wherein the resource parameter characterizes a resource required to be transferred for obtaining a viewing permission for the target live stream room, and the target live stream room is configured to open to a client of an audience which obtains the viewing permission for the target live stream room.

According to a second aspect, an embodiment of the present disclosure provides for creating a target live stream room, which is applied to a server, and the method includes:

receiving a creation request transmitted by a client of a streamer, and obtaining a live stream parameter based on the creation request, wherein the live stream parameter comprises a resource parameter; and creating, based on the live stream parameter, a target live stream room corresponding to a first streamer identifier at the server, wherein the resource parameter characterizes a resource required to be transferred for obtaining a viewing permission for the target live stream room, and the target live stream room is configured to open to a client of an audience which obtains the viewing permission for the target live stream room.

According to a third aspect, an embodiment of the present disclosure provides an apparatus for creating a target live stream room, which is applied to a client of a streamer, and the apparatus includes:
a displaying module configured to display, in response to a first input operation, a first configuration page corresponding to a first streamer identifier;
a processing module configured to obtain, in response to a second input operation for the first configuration page, a live stream parameter, wherein the live stream parameter comprises a resource parameter, and the resource parameter characterizes a resource required to be transferred for obtaining a viewing permission for the target live stream room; and
a transmitting and receiving module configured to transmit a creation request to a server based on the live stream parameter, such that the server creates a target live stream room corresponding to the first streamer identifier, wherein the target live stream room is configured to open to a client of an audience which obtains the viewing permission for the target live stream room.

According to a fourth aspect, an embodiment of the present disclosure provides an apparatus for creating a target live stream room, which is applied to a server, and the apparatus includes:
a transmitting and receiving module configured to receive a creation request transmitted by a client of a streamer, and obtain a live stream parameter based on the creation request, wherein the live stream parameter comprises a resource parameter, and the resource parameter characterizes a resource required to be transferred for obtaining a viewing permission for the target live stream room; and
a creating module configured to create, based on the live stream parameter, a target live stream room corresponding to a first streamer identifier at the server, the target live stream room being configured to open to a client of an audience which obtains the viewing permission for the target live stream room.

In a fifth aspect, an embodiment of the present disclosure provides an electronic device, including:
a processor and a memory communicatively connected to the processor;
the memory stores a computer execution instruction;
the processor executes the computer execution instruction stored in the memory, to implement the method for creating a target live stream room according to the first aspect and various possible designs of the first aspect, or implement the method for creating a target live stream room according to the second aspect and the various possible designs of the second aspect.

According to a sixth aspect, an embodiment of the present disclosure provides a computer readable storage medium. The computer readable storage medium stores a computer execution instruction, and when executing the computer execution instruction, a processor implements the method for creating a target live stream room according to the first aspect and various possible designs of the first aspect, or, implements the method for creating a target live stream room according to the second aspect and various possible designs of the second aspect.

According to a seventh aspect, an embodiment of the present disclosure provides a computer program product including a computer program. When being executed by a processor, the computer program implements the method for creating a target live stream room according to the first aspect and various possible designs of the first aspect, or implements the method for creating a target live stream room according to the second aspect and various possible designs of the second aspect.

According to an eighth aspect, an embodiment of the present disclosure provides a computer program. When being executed by a processor, the computer program implements the method for creating a target live stream room according to the first aspect and various possible designs of the first aspect, or implements the method for creating a target live stream room according to the second aspect and various possible designs of the second aspect.

### BRIEF DESCRIPTION OF THE DRAWINGS

In order to more clearly illustrate the technical solutions in the embodiments of the present disclosures or prior art, the following will be a brief introduction to the accompanying drawings required for the description of the embodiments or the prior art. Obviously, the accompanying drawings in the following description relate to some embodiments of the present disclosure. For those of ordinary skill in the art, other drawings can be obtained according to these drawings without creative labor.

FIG. 1 is a schematic diagram of a live broadcast system framework provided by an embodiment of the present disclosure;

FIG. 2 is a schematic flowchart one of a method for creating a target live stream room provided by an embodiment of the present disclosure;

FIG. 3 is a schematic diagram of a first configuration page provided by an embodiment of the present disclosure;

FIG. 4 is a schematic diagram of another first configuration page provided by an embodiment of the present disclosure;

FIG. 5 is a schematic flowchart two of a method for creating a target live stream room provided by an embodiment of the present disclosure;

FIG. 6 is a schematic diagram of a second configuration page provided by an embodiment of the present disclosure;

FIG. 7 is a schematic flowchart three of a method for creating a target live stream room provided by an embodiment of the present disclosure;

FIG. 8 is a schematic diagram of a third configuration page provided by an embodiment of the present disclosure;

FIG. 9 is a schematic flowchart of a method for creating a target live stream room provided by an embodiment of the present disclosure;

FIG. 10 is a flowchart of a specific implementation of step S404 in the embodiment shown in FIG. 9;

FIG. 11 is a structural block diagram of an apparatus for creating a target live stream room applied to a client of a streamer provided by an embodiment of the present disclosure;

FIG. 12 is a structural block diagram of an apparatus for creating a target live stream room applied to a server provided by an embodiment of the present disclosure;

FIG. 13 is a schematic structural diagram of an electronic device provided by an embodiment of the present disclosure;

FIG. 14 is a hardware schematic structural diagram of an electronic device provided by an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings in the embodiments of the present disclosure. Obviously, the described embodiments are only a part but not all of the embodiments of the present disclosure. All other embodiments obtained by those skilled in the art based on the embodiments of the present disclosure without creative efforts shall belong to the scope of protection of the present disclosure.

Application scenarios of the embodiments of the present disclosure will be explained below:

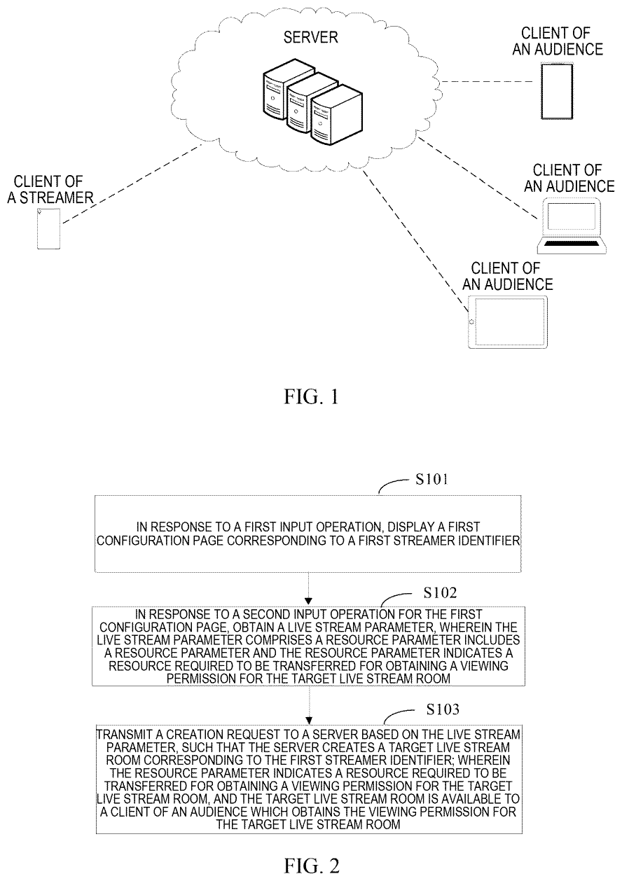

The method for creating a target live stream room provided in the embodiment of the present disclosure can be applied to an application scenario of creating a paid live broadcast service in a live broadcast system. Specifically, FIG. 1 is a schematic diagram of a live broadcast system framework provided by an embodiment of the present disclosure, as shown in FIG. 1, the live broadcast system includes a server, a client of a streamer and a client of an audience, wherein the server provides a related live broadcast service to the client of a streamer and the client of an audience, such that the user of the client of an audience can watch the live content shot by the client of a streamer. Exemplarily, a server is running on a server, a client of an audience and a client of a streamer are respectively running on terminal devices, the server is realized by running a corresponding server program, and the client of a streamer and the client of an audience are realized by running corresponding application programs. The embodiment of the present disclosure provides a method for creating a target live stream room applied to a client of a streamer, and the corresponding execution body is a terminal device. The embodiment of the present disclosure provides a method for creating a target live stream room applied to a server, end and the corresponding execution body is a server.

In the related art, before a paid live broadcast of a large-scale activity is started to broadcast, a live broadcast platform will directly create live broadcast information about a paid live stream room at a serving end, and promote a viewing permission of the paid live broadcast; and at the streamer side, the paid live broadcast cannot be created autonomously. In the related art, a paid live stream room is directly created at a server by a live broadcast platform, and the number of audiences when the live broadcast is formally started is predicted by selling the viewing permission in advance (for example, selling a virtual ticket of an online concert in advance), so as to prepare corresponding server resources.

However, with regard to the described establishment process of the paid live stream room or conducting a paid performance offline, there are problems such as complex flow, long time consumption and low efficiency, and the user interaction requirements cannot be met, thereby affecting the promotion of the paid live broadcast service. An embodiment of the present disclosure provides a method for creating a target live stream room to solve the above problem.

Referring to FIG. 2, FIG. 2 is a schematic flowchart one of a method for creating a target live stream room provided by an embodiment of the present disclosure. The method of the present embodiment can be applied to a client of a streamer. Exemplarily, the execution body of the method of the present embodiment is a terminal device, and the client of a streamer runs on the terminal device. The method for creating a target live stream room includes:

At step S101, in response to a first input operation, a first configuration page corresponding to a first streamer identifier is displayed.

Exemplarily, the terminal device is, for example, a smart phone, and the client of a streamer is, for example, a live broadcast APP at the streamer side which runs on a terminal device. The smart phone has a touch screen for human-computer interaction, and a user at the streamer side implements a first input operation on the terminal device via a touch screen. The first input operation is, for example, an operation of creating a live stream room, and more specifically, the first input operation is, for example, clicking or sliding a first trigger control in the APP, such that the first trigger control is triggered to display the first configuration page, and the first trigger control is, for example, a button. The first configuration page corresponds to the first streamer identifier. Specifically, the first streamer identifier is, for example, an streamer ID. The above-mentioned APP at the streamer side is logged in via the first streamer identifier, and communicates with a corresponding service end based on the first streamer identifier. The first configuration page is configured to create a page of the paid live stream room corresponding to the first streamer identifier.

Exemplarily, the first streamer identifier corresponds to a different user permission, that is, different first streamer identifiers (for example, user IDs) correspond to different first configuration pages. In an exemplary implementation, creation of a charging live stream room can be performed only in a first configuration page of a first streamer identifier having a corresponding permission; whereas, the live stream room cannot be created in the first configuration page of the first streamer ID having no corresponding permission. That is, different first configuration pages are displayed for different first streamer identifiers.

Further, the displayed first configuration page further includes at least one trigger control for the user to create a paid live stream room; and after a trigger operation of the user on the trigger control in the first configuration page is received, corresponding steps for creating the live stream room are executed, and a specific implementation thereof will be described in detail in subsequent steps, and thus will not be described in detail herein. There may be a variety of specific implementations for the first configuration page and a variety of specific manners for displaying the first configuration page, which may be set as required, and will not be illustrated here.

At step S102: in response to a second input operation for the first configuration page, a live stream parameter is obtained, wherein the live stream parameter includes a resource parameter and the resource parameter characterizes a resource required to be transferred for obtaining a viewing permission for the target live stream room.

Further, similarly, the user of the streamer side implements a second input operation for the first configuration page on the terminal device through the touch screen, so as to input the live stream parameter. Specifically, for example, the second input operation is, for example, inputting a corresponding character string in the first configuration page, such that the client of a streamer obtains a corresponding live stream parameter to create a charging live stream room. More specifically, for example, the second input operation is inputting title of the live stream room, start time of the live stream room, an introduction of the live stream room, charging information of the live stream room, or the like within the first configuration page.

The live stream parameter at least includes a resource parameter, and the resource parameter characterizes a resource required to be transferred for obtaining a viewing permission for the target live stream room. In an application scenario of a charging live stream room, the audience terminal needs to have a viewing permission for the charging live stream room to watch the live broadcast, and the viewing permission needs to be obtained by transferring a resource between accounts. The resource is, for example, a score, and the resource parameter is a numerical value (such as a score) of a specific resource required to be transferred (transacted/paid) for the viewing permission, that is, the value of the resource. For example, the user may pay 300 scores to obtain the viewing permission, and certainly there may also be another type of resource, which is not limited in the present disclosure. The viewing permission can be obtained after the account of client of an audience pays a resource of the corresponding value. Further, the live stream parameter may also include a time parameter, and the time parameter indicates live broadcast time of the live stream room. Yet further, the live stream parameter may further include a name parameter of live stream room, an introduction parameter of live stream room, and the like, which are configured for determining information such as a name and introduction of a live stream room, and the description thereof will not be provided by way of example.

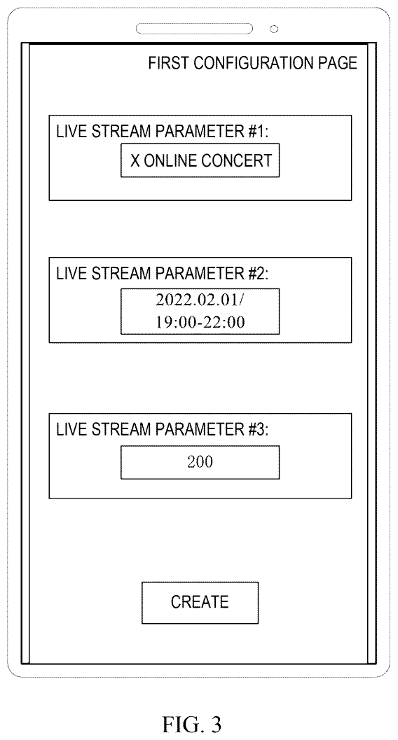

FIG. 3 is a schematic diagram of a first configuration page provided by an embodiment of the present disclosure. As shown in FIG. 3, the first configuration page includes an input control A, an input control B, and an input control C. The input control A is configured for obtaining a live stream parameter #1 characterizing a live stream room name; the input control B is configured for obtaining a live stream parameter #2 characterizing live broadcast time; and the input control C is configured for obtaining a live stream parameter #3 characterizing the “charging” information of the paid live stream room. Exemplarily, based on the second input operation, the obtained live stream parameters are respectively a live stream parameter #1: “X online concert”, a live stream parameter #2: “2022.02.01/19:00-22:00” and a live stream parameter #3: “200 points”. The live stream parameter #3 is a resource parameter. In a possible implementation, there may be default values for live stream parameter that characterizes the live stream room name and the live stream parameter that characterizes the live broadcast time (namely, a default live stream room name and current time), thus the input thereof is not required (namely, not contained in the second input operation), and only the live stream parameter that characterizes the “charging” information needs to be obtained. That is, the second input operation only includes information corresponding to the resource parameter.

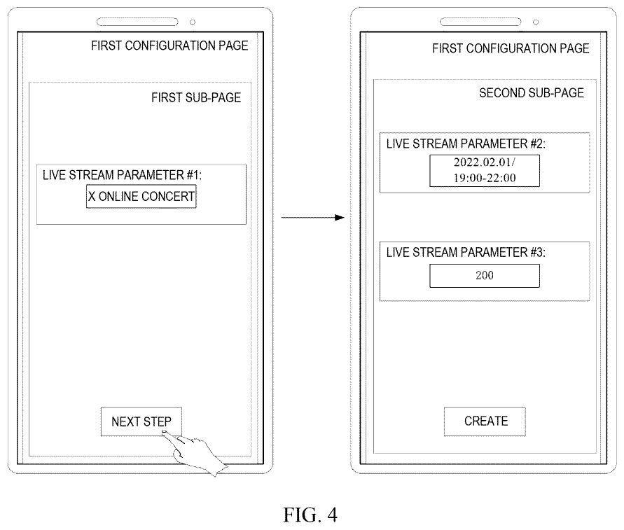

For example, the live stream parameter is a parameter required for establishing a charging live stream room, and the process of the client of a streamer obtaining the live stream parameter may be obtained based on one operation. Referring to the schematic diagram of the first configuration page shown in FIG. 3, in response to the second input operation (after the user clicks the “create” button), the client of a streamer obtains all the live stream parameters at one time. In another possible implementation, the live stream parameter may also be obtained based on a plurality of operations. FIG. 4 is a schematic diagram of another first configuration page provided in an embodiment of the present disclosure, and as shown in FIG. 4, the first configuration page includes a first sub-page and a second sub-page; the second input operation includes filling corresponding information to the input control A in the first sub-page, and then the client of a streamer obtains the live stream parameter #1. For example, after the user clicks the “next’ control, the first configuration page displays the second sub-page, the second input operation further includes filling corresponding information into the input control B and the input control C in the second sub-page, and then the client of a streamer obtains the live stream parameter #2 and the live stream parameter #3. Certainly, it can be understood that there are other implementations for obtaining the live stream parameter, which may be set according to specific requirements, and details are not described herein again.

Step S103: a creation request is transmitted to a server based on the live stream parameter, such that the server creates a target live stream room corresponding to the first streamer identifier; wherein the target live stream room is configured to open to a client of an audience which obtains the viewing permission for the target live stream room. The viewing permission for the target live stream room is obtained after the client of an audience performs resource transfer based on the resource parameter of the target live stream room.

Exemplarily, after the live stream parameter is obtained, a corresponding creation request is generated based on the live stream parameter and then transmitted to the server, such that the server creates, on the live broadcast platform, a paid live stream room corresponding to the first streamer identifier and based on the live stream parameter, that is, a target live stream room. After the server creates the target live stream room, the client of an audience may obtain a link of the target live stream room by means of recommendation information, searching, etc., so as to pay for the viewing permission for the target live stream room, thereby obtaining the viewing permission. Specifically, for example, a virtual ticket of the target live stream room is paid by using a score, such that the client of an audience which obtains the viewing permission has permission to watch after the target live stream room is started to broadcast.

In the above process, when creating the target live stream room based on paid live broadcast, the server creates the target live stream room based on the live stream parameter transmitted by the client of a streamer and the corresponding first streamer identifier, which not only realizes the purpose of rapidly creating a paid live stream room that meets the streamer's requirement, but also enables an streamer user to create a paid live broadcast autonomously; corresponding account management and server resource allocation may also be performed based on the first streamer identifier, so as to ensure the live broadcast quality of the paid live stream room.

In this embodiment, in response to a first input operation, a first configuration page corresponding to a first streamer identifier is displayed; in response to a second input operation for the first configuration page, a live stream parameter is obtained, wherein the live stream parameter includes a resource parameter, the resource parameter characterizes a resource required to be transferred for obtaining a viewing permission for the target live stream room; and a creation request is transmitted to a server based on the live stream parameter, such that the server creates a target live stream room corresponding to the first streamer identifier; wherein the target live stream room is configured to open to a client of an audience which obtains the viewing permission for the target live stream room, and the viewing permission for the target live stream room is obtained after the client of an audience performs resource transfer based on the resource parameter of the target live stream room. In this way, the streamer user can autonomously create a charging live stream room at the client of a streamer, thereby simplifying the creation flow for the paid live stream room. In this way, the establishment efficiency of the charging live broadcast is improved.

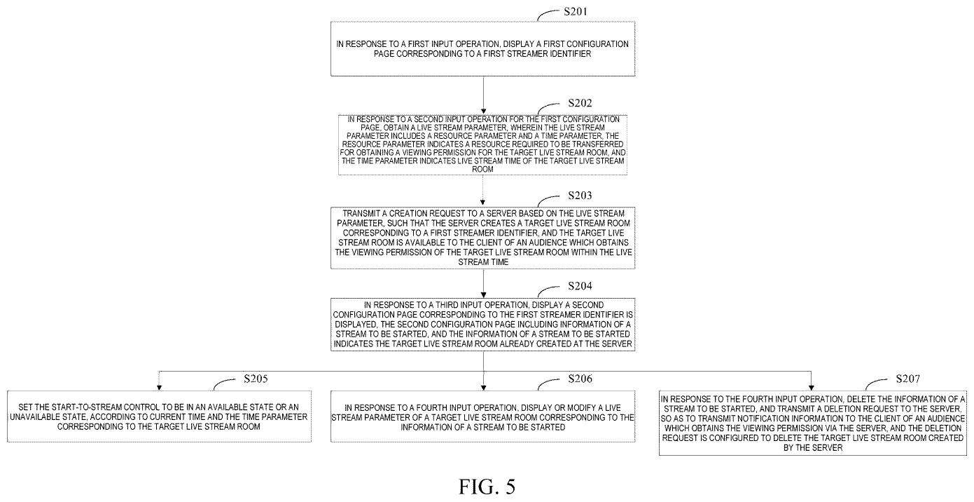

Referring to FIG. 5, FIG. 5 is a second schematic flowchart of a method for creating a target live stream room according to an embodiment of the present disclosure. On the basis of the embodiment shown in FIG. 2, this embodiment further adds a step of managing the created target live stream room. The method for creating a target live stream room includes:

Step S201: In response to a first input operation, a first configuration page corresponding to a first streamer identifier is displayed.

Step S202: in response to a second input operation for the first configuration page, a live stream parameter is obtained, wherein the live stream parameter includes a resource parameter and a time parameter, the resource parameter characterizes a resource required to be transferred for obtaining a viewing permission for the target live stream room, and the time parameter characterizes live broadcast time of the target live stream room.

Step S203: a creation request is transmitted to a server based on the live stream parameter, such that the server creates a target live stream room corresponding to a first streamer identifier, and the target live stream room is open to the client of an audience which obtains the viewing permission of the target live stream room within the live broadcast time.

Step S204: in response to a third input operation, a second configuration page corresponding to the first streamer identifier is displayed, the second configuration page including information of a stream to be started information, and the information of a stream to be started information characterizes the target live stream room already created at the server.

Exemplarily, the third input operation is an operation input by the user for triggering display of the second configuration page, for example, an operation of opening the second configuration page to display the second configuration page on the touchscreen; more specifically, for example, the third input operation is a click operation for a corresponding second trigger control. After the second trigger control in the APP of the client of a streamer is clicked (namely, the third input operation), the streamer hangs up the second configuration page to display, wherein the second trigger control is, for example, a button within the second configuration page. Specific implementations are based on related technologies that are executed by those skilled in the art, and are not described herein again.

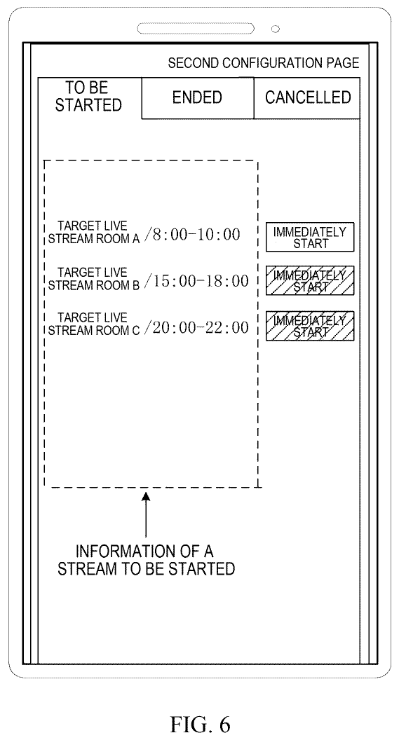

Further, the second configuration page is a page configured for viewing and editing the created target live stream room, and the second configuration page corresponds to the first streamer identifier, i.e. the second configuration page displays the paid live stream room created by the user currently logged into the client of a streamer. The second configuration page includes information of a stream to be started information. Exemplarily, the information of a stream to be started information characterizes the target live stream room already created at the server. FIG. 6 is a schematic diagram of a second configuration page provided by an embodiment of the present disclosure. As shown in FIG. 6, the second configuration page includes information of a stream to be started information, which is set in a “information of a stream to be started” sub-page. Exemplarily, the information of a stream to be started information includes a target live stream room A, a target live stream room B, a target live stream room C displayed in a list form, and live broadcast time corresponding thereto. The streamer user can see the created paid live broadcast session (the target live stream room) through the second configuration page of the streamer user. Meanwhile, exemplarily, the second configuration page can further include an “ended” sub-interface and a “cancelled” sub-interface, and after live broadcast of the target live stream room in the information of a stream to be started information is ended, the “ended” sub-interface is entered for display; after the target live stream room in the information of a stream to be started information is cancelled, a “cancelled” sub-interface is entered for display, and the specific implementation may be similar to the implementation of displaying the information of a stream to be started information in the “information of a stream to be started” sub-interface, or may be set as required, which will not be described herein again.

It should be noted that, the target live stream room in this embodiment may refer to a live broadcast task and a live broadcast session of a live broadcast that has a unique live broadcast identifier, for example, the client of a streamer corresponding to the first streamer identifier creates a target live stream room A at 8-10 AM on January 1st to perform a paid live broadcast, creates a target live stream room B at 15-18 PM on the same day to perform another paid live broadcast. In this case, each of two live broadcast sessions in the morning and in the afternoon corresponds to one target live stream room.

Exemplarily, start-to-broadcast controls are provided within the second configuration page, wherein the start-to-broadcast controls corresponds one-to-one to the target live stream rooms characterized by the start-to-broadcast information, and the start-to-broadcast control is configured to immediately start the corresponding target live stream room. Specifically, as shown in FIG. 6, the start-to-broadcast control is, for example, an “Immediately start” button in FIG. 6, and after performing a click operation on the start-to-broadcast control, the user may directly start a live broadcast session corresponding to the target live stream room. Further, the “Immediately start” button can be triggered out of the live broadcast time, for example, if the live stream parameter determined according to the time parameter corresponding to the target live stream room A is 8 o'clock to 10 o'clock, after 7:30 on the same day, the user may start the target live stream room in advance by clicking the “Immediately start” button when the start-to-broadcast time (8 o'clock) is not yet reached, thereby improving the operation flexibility of the streamer in the process of the paid live broadcast.

Optionally, after step S204, the method further comprises:

Step S205: the start-to-broadcast control is set to be in an available state or an unavailable state, according to current time and the time parameter corresponding to the target live stream room.

Exemplarily, the time parameter includes a live broadcast start time, and with reference to a control in a second configuration page as shown in FIG. 6, in order to ensure the accuracy of start-to-broadcast of a paid live broadcast and prevent the problem of starting to broadcast by mistake from affecting the user's viewing experience, the start-to-broadcast is set to be in an available state or an unavailable state according to the current system time, and as shown in FIG. 6, exemplarily, the start-to-broadcast control corresponding to a target live stream room A is in an available state; the start-to-broadcast controls corresponding to the target live stream room B and the target live stream room C are in an unavailable state; specifically, if the difference between the current time and the live broadcast start time corresponding to the time parameter is greater than a first preset duration, the start-to-broadcast control is set to be in an unavailable state; and if the difference between the current time and the live broadcast start time corresponding to the time parameter is shorter than the first preset duration, the play control is set to be in the available state.

Optionally, after step S204, the method further includes:

Step S206: in response to a fourth input operation, a live stream parameter of a target live stream room corresponding to the information of a stream to be started information is displayed or modified.

Exemplarily, a target live stream room is generated based on a live stream parameter, and therefore, in order to ensure the autonomy and flexibility of the streamer for the paid live broadcast, based on a fourth input operation input by the streamer user, a live stream parameter of a target live stream room corresponding to information of a stream to be started information can be modified at the client of a streamer, and the fourth input operation may be an editing operation for a live stream parameter. More specifically, the fourth input operation is, for example, inputting a specific numerical value into an input control corresponding to the live stream parameter to edit the live stream parameter, and the input control is listed as an editable text box (EditText). That is, the live stream parameter of the paid live stream room created by the client of a streamer corresponding to the first streamer identifier is modified, for example, the live broadcast start time and the live broadcast end time (time parameters) of the target live broadcast are modified, and resources (resource parameters) required to be transferred for obtaining a viewing permission for the target live stream room are modified. Thus, the streamer can manage the paid live stream room more flexibly (for example, temporarily extending the performance time, selling virtual tickets at a discount, etc.). In this way, the user experience of the user viewing the paid live stream room is improved.

Optionally, after step S204, the method further comprises:

Step S207: in response to the fourth input operation, the information of a stream to be started information is deleted, and a deletion request is transmitted to the server, so as to transmit notification information to the client of an audience which obtains the viewing permission via the server, and the deletion request is configured to delete the target live stream room created by the server.

Exemplarily, similar to step S206, for a target live stream room corresponding to the information of a stream to be started information, in addition to editing, the client of a streamer may trigger, based on a fourth input operation input by the user, a deletion control corresponding to the target live stream room, so as to delete the target live stream room. Alternatively, the deletion control is available when the corresponding target live stream room has not been broadcast, and after the deletion control is triggered, the target live stream room corresponding to the information of a stream to be started information is first deleted in the second configuration page of the client of a streamer, and then, the client of a streamer transmits a deletion request to the server, such that the server deletes the information corresponding to the target live stream room in synchronization. Further, the server may also transmit notification information to a client of an audience that has obtained the viewing permission, so as to inform the client of an audience that the live broadcast is cancelled.

In this embodiment, after the client of a streamer creates a target live stream room for implementing the paid live broadcast, relevant operations of viewing, editing and deleting the target live stream room are performed in the second configuration page, so as to enable the streamer to have a better management path for the created paid live room, thereby, improving the broadcast flexibility of the paid live stream room, reducing the cost of the user of the streamer terminal in managing the paid live stream room, and improving the experience of the user of the client of a streamer in viewing the paid live stream room.

In this embodiment, implementation manners of step S201 to step S203 are the same as implementation manners of step S101 to step S101 in the embodiment shown in FIG. 2 of the present disclosure, which are not repeatedly described herein.

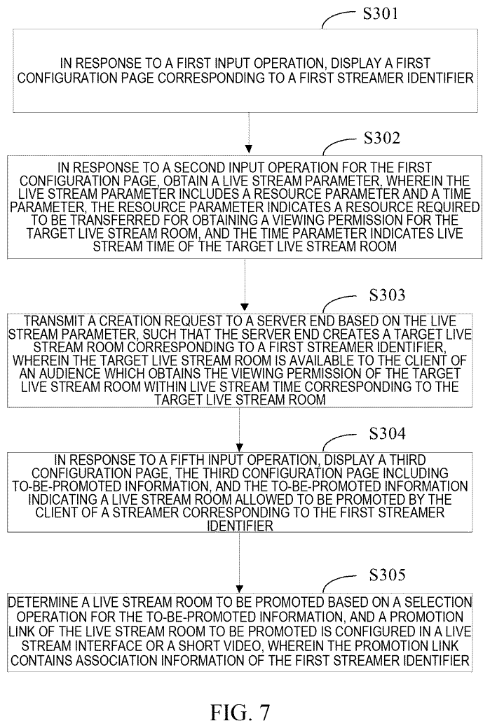

Referring to FIG. 7, FIG. 7 is a schematic flowchart three of a method for creating a target live stream room according to an embodiment of the present disclosure. On the basis of the embodiment shown in FIG. 2, this embodiment further adds a step of promoting the target live stream room, and the method for creating a target live stream room includes:

Step S301: in response to a first input operation, a first configuration page corresponding to a first streamer identifier is displayed.

Step S302: in response to a second input operation for the first configuration page, a live stream parameter is obtained, wherein the live stream parameter includes a resource parameter and a time parameter, the resource parameter characterizes a resource required to be transferred for obtaining a viewing permission for the target live stream room, and the time parameter characterizes live broadcast time of the target live stream room.

Step S303: a creation request is transmitted to a server based on the live stream parameter, such that the server creates a target live stream room corresponding to a first streamer identifier, wherein the target live stream room is open to the client of an audience which obtains the viewing permission of the target live stream room within the corresponding live broadcast time corresponding to the target live stream room.

Step S304: in response to a fifth input operation, a third configuration page is displayed, the third configuration page including to-be-promoted information, and the to-be-promoted information characterizing a live stream room allowed to be promoted by the client of a streamer corresponding to the first streamer identifier.

Exemplarily, the fifth input operation is an operation, input by the user, for triggering display of the third configuration page. Specifically, for example, a click operation may be performed on a corresponding third trigger control. After the third trigger control in the APP of the client of a streamer is clicked (namely, a third input operation), a client of a streamer hangs up a third configuration page for display, and the specific implementation is a relevant technique executed by those skilled in the art, which will not be described herein repeatedly.

Further, the third configuration page is a page for promoting a live stream room, the third configuration page includes to-be-promoted information, and the to-be-promoted information characterizes a live stream room allowed to be promoted by the client of a streamer corresponding to the first streamer identifier. Specifically, in an application scenario of a paid live broadcast, compared with a mode in the related art in which a paid live stream room is directly created at a server via a live broadcast platform, in this embodiment, after creating a target live stream room for implementing the paid live broadcast, the client of a streamer displays the to-be-promoted information via a third configuration page, thereby improving promotion effects of the paid live stream room.

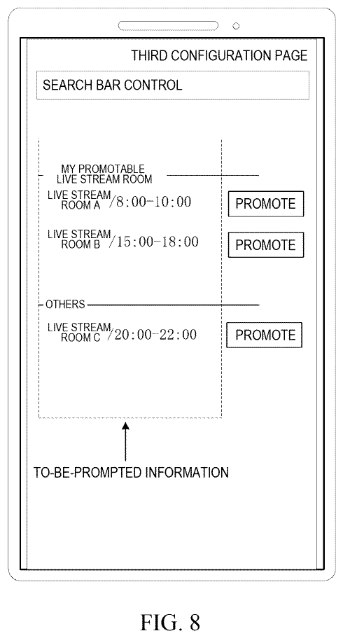

Exemplarily, FIG. 8 is a schematic diagram of a third configuration page provided by an embodiment of the present disclosure. As shown in FIG. 8, the to-be-promoted information is provided within a third configuration page, and specifically, the to-be-promoted information includes a to-be-promoted list, and the to-be-promoted list includes a plurality of paid live stream rooms. Through selecting the paid live stream rooms from the to-be-promoted list (shown as live stream room A, live stream room B and live stream room C), for example, by clicking the “promotion” button corresponding to each live stream room, the promotion can be realized.

The to-be-promoted information has a corresponding relationship with the first streamer identifiers, that is, live stream rooms that can be prompted by different streamer identifiers are different, for example, the first streamer identifier a has a promotion permission for a paid live stream room X, and therefore the paid live stream room X can be promoted by the first streamer identifier a (namely, the to-be-promoted information includes the paid live stream room X); the first streamer identifier b does not have a promotion permission for the paid live stream room X, and the paid live stream room X cannot be promoted by the first streamer identifier b (namely, the to-be-promoted information does not include the paid live stream room X).

Exemplarily, the to-be-promoted information includes first promotion information and/or second promotion information, wherein the first promotion information characterizes a target paid live broadcast corresponding to the first streamer identifier, and the second promotion information characterizes a paid live broadcast corresponding to the second streamer identifier. That is, the user at the client of a streamer may promote his/her own paid live broadcast, or promote the paid live broadcast of another streamer. As shown in FIG. 8, in the to-be-promoted information of the first streamer identifier, the live stream room A and the live stream room B are paid live stream rooms created by the client of a streamer corresponding to the first streamer identifier (shown as “My promotable live stream rooms” entries in the drawing); the live stream room C is a paid live stream room created by another client of a streamer (shown as “another” item in the drawing). By clicking the “promotion” button corresponding to different live stream rooms, the paid live stream room created by the client of a streamer corresponding to the first streamer identifier (namely, the target live stream room in the foregoing step) or a paid live broadcast center created by another client of a streamer can be prompted, and a specific promotion implementation process is introduced in subsequent steps.

Step S305: a live stream room to be promoted is determined based on a selection operation for the to-be-promoted information, and a promotion link of the live stream room to be promoted is configured in a live broadcast interface or a short video, wherein the promotion link contains association information of the first streamer identifier.

Exemplarily, fourth trigger controls are provided within the second configuration page, wherein the fourth trigger controls correspond one-to-one to the live stream rooms indicated by the to-be-promoted information, and the fourth trigger control is configured for generating promotion link containing the association information of the first streamer identifier. Exemplarily, the fourth trigger control is a control for obtaining and configuring a promotion link. Specifically, as shown in FIG. 8, the fourth trigger control is, for example, a “promotion” button, and the user hangs up, by clicking the “promotion” button (namely, a selection operation for the to-be-promoted information), a promotion interface for configuring a promotion link of a live broadcast or a short video. In the promotion interface, the previously generated promotion link and the corresponding identifier (such as the title and the promotion picture of the paid live stream room) are configured into a short video template used when the short video is published by the streamer corresponding to the first streamer identifier, or configured to the live broadcast template used when the streamer corresponding to the first streamer identifier performs live broadcast. Then, when the streamer corresponding to the first streamer identifier performs a general live broadcast or records a short video, the promotion link and the corresponding identifier may be automatically inserted into the live broadcast interface or the short video based on the live broadcast template and the short video template, thereby realizing the promotion. The promotion link includes association information of the first streamer identifier. Exemplarily, the association information may have a one-to-one mapping relationship with the first streamer identifier, thus a character string of the first streamer identifier can be uniquely determined. When the client of an audience performs resource transfer (for example, purchasing a virtual ticket) by means of a promotion link promoted by the first streamer identifier, the account corresponding to the first streamer identifier will obtain a corresponding resource reward, for example, the account of the first streamer identifier will obtain a certain reward resource. Thus, the award for promotion by the streamer is realized, the enthusiasm of promotion by the streamer is improved, the promotion effect is improved, and the interactive experience is further enriched.

Exemplarily, a search bar control is further included in the third configuration page, and reference is made to the search bar control shown in FIG. 8. The method of this embodiment further includes: in response to a sixth operation, obtaining keyword information; and searching, by a server, target to-be-promoted information corresponding to the keyword information, and displaying the target to-be-promoted information on the third configuration page. By providing the search bar, the flexibility of the user of the client of a streamer in promoting the paid live broadcast can be further improved, and the promotion effect can be improved.

In this embodiment, by setting a third configuration page, the user of the client of a streamer can flexibly promote a paid live stream room, thus on the one hand, there is provided a channel for a user corresponding to a first streamer identifier to prompt a target live stream room created by the user itself, and on the other hand, a channel for other streamer to prompt the target live stream room is also provided, thereby improving effects of promoting the target live stream room.

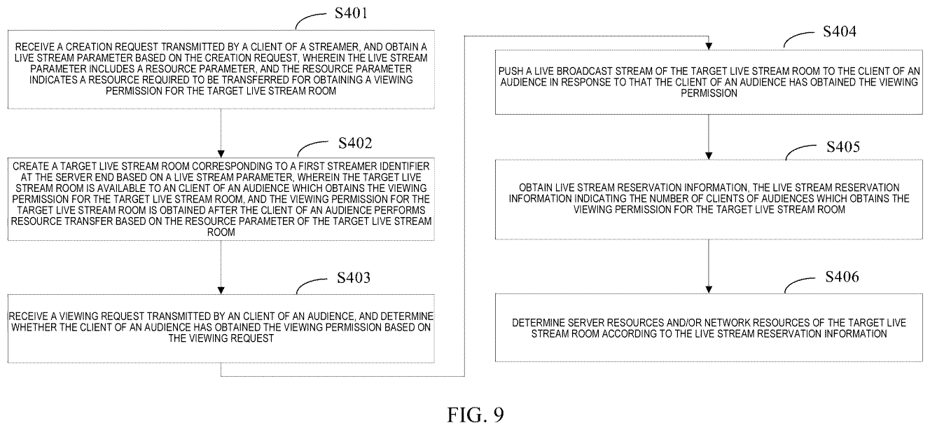

FIG. 9 is a schematic flowchart of a method for creating a target live stream room provided by an embodiment of the present disclosure. The method of this embodiment may be applied to a server. Exemplarily, an execution body of the method of this embodiment is a server, and the server runs in the server. The method for creating a target live stream room includes:

Step S401: a creation request transmitted by a client of a streamer is received, and a live stream parameter is obtained based on the creation request, wherein the live stream parameter includes a resource parameter, and the resource parameter characterizes a resource required to be transferred for obtaining a viewing permission for the target live stream room.

Step S402: a target live stream room corresponding to a first streamer identifier is created at the server based on a live stream parameter, wherein the target live stream room is configured to open to a client of an audience which obtains the viewing permission for the target live stream room, and the viewing permission for the target live stream room is obtained after the client of an audience performs resource transfer based on the resource parameter of the target live stream room.

Exemplarily, the method for creating a target live stream room provided by the present embodiment is applied to a server, and corresponds to the method for creating a target live stream room applied to the client of a streamer provided by the embodiment shown in FIG. 2, that is, a specific responding method at the server after the client of a streamer transmits the creation request to the server. Specifically, after receiving a creation request transmitted by the client of a streamer, the server performs parsing based on the message information of the creation request, such as, a message characterizing a first streamer identifier and a live stream parameter, to obtain the first streamer identifier and the live stream parameter, wherein the live stream parameter at least includes a resource parameter, and the resource parameter characterizes required to be transferred for obtaining a viewing permission for the target live stream room. For the specific implementation of the resource parameters, reference may be made to the relevant description of setting the resource parameter by the client of a streamer in the embodiment shown in FIG. 2, which will not be described herein again.

Optionally, the live stream parameter further includes a time parameter, and the time parameter characterizes the live broadcast time of the live stream room, for example, start broadcast time and end broadcast time of the live stream room. Further, the live stream parameter may include a live stream room name parameter, a live stream room introduction information parameter, and the like, and is used to further configure the target live stream room created in the following steps. For a specific implementation, reference may be made to relevant introduction in the embodiment shown in FIG. 2, and details are not repeatedly described herein. By means of the embodiments of the present disclosure, a response to a creation request corresponding to a first streamer identifier can be realized, and a paid live stream room which is initiated by a client of a streamer and corresponding to the first streamer identifier and the live stream parameter is created, such that the fast creation of the paid live stream room is realized, the creation flow of the paid live stream room is shortened, and thus the creation efficiency is improved.

Further, after the live stream parameter is determined, a paid live stream room is created based on the first streamer identifier and the live stream parameter, i.e. a target live broadcast station created by the client of a streamer, wherein the target live stream room is triggered by a creation request corresponding to a first streamer identifier, therefore, it corresponds to the first streamer identifier, and more specifically, the target live stream room is bound to the first streamer identifier, thus, subsequent steps such as resource transfer (namely, income of the live stream room), automatic configuration of server resources and network resources, are implemented. After the server creates the target live stream room, the client of an audience may obtain the viewing permission for the target live stream room by means of resource transfer (namely, purchasing a virtual ticket), such that after the target live stream room is started to broadcast, the client of an audience may watch the live broadcast.

Optionally, after step S402, the method further includes:

Step S403: a viewing request transmitted by a client of an audience is received, and whether the client of an audience has obtained the viewing permission is determined based on the viewing request.

Step S404: live broadcast stream of the target live stream room is pushed to the client of an audience in response to that the client of an audience has obtained the viewing permission.

Exemplarily, after a target live stream room is created, a client of an audience may transmit a viewing request with respect to the target live stream room to a server, wherein the viewing request contains a unique identification identifier corresponding to the client of an audience; and the server determines whether the client of an audience who transmits the viewing request has a viewing permission according to the unique identification identifier, and if so, a live broadcast stream of the target live stream room is pushed to the client of an audience. Optionally, before pushing the live broadcast stream of the target live stream room to the client of an audience, the method further includes: further determining whether the time corresponding to the viewing request is within the live broadcast time, and if the time corresponding to the viewing request is within the live broadcast time, pushing the live broadcast stream of the target live stream room to the client of an audience.

Specifically, the method for determining whether the client of an audience has obtained the viewing permission includes:

obtain payment information of a client of an audience according to the viewing request; and determining whether the client of an audience has obtained the viewing permission according to the payment information and the live stream parameter.

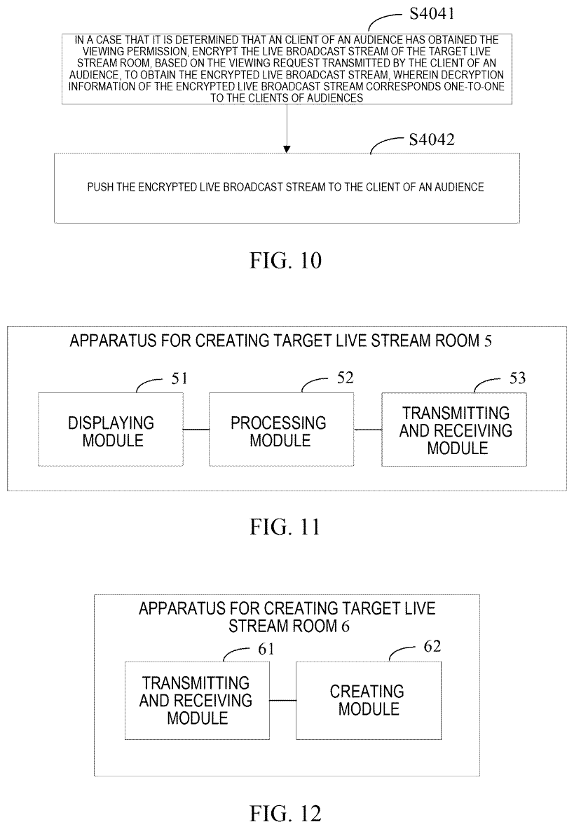

Exemplarily, as shown in FIG. 10, the specific implementation step of step S404 includes:

Step S4041: in a case that it is determined that a client of an audience has obtained the viewing permission, the live broadcast stream of the target live stream room is encrypted, based on the viewing request transmitted by the client of an audience, to obtain the encrypted live broadcast stream, wherein decryption information of the encrypted live broadcast stream corresponds one-to-one to the clients of audiences.

Step S4042: the encrypted live broadcast stream is pushed to the client of an audience.

Exemplarily, in step S403, based on the viewing request of the client of an audience, a step of authenticating the viewing permission of the client of an audience is performed. Through the described steps, it can be ensured that the client of an audience which can watch the live content of the target live stream room has paid the fee, thereby guaranteeing the revenue of the live stream room. On the other hand, in the steps of the present embodiment, the live stream received by the client of an audience which obtains the viewing permission is further dynamically encrypted, i.e. the server allocates unique encryption identifiers to target client of audiences which obtains the viewing permission, and pieces of the decryption information corresponds one-to-one to the encryption identifiers, i.e. the decryption information is one-to-one bound to the target client of audiences. Therefore, only a client of an audience having decryption information can decrypt and watch the encrypted live broadcast stream, and the other client of audiences, even if they have obtained the encrypted live broadcast stream, cannot watch the encrypted live broadcast stream because there is no corresponding decryption information, thereby avoiding a chain stealing behavior, and thus ensuring safe playback of the target live stream room. In this embodiment, the validity of the paid live stream room is ensured by authentication of the client of an audience and encryption of the live broadcast stream.

Optionally, after step S404, the method further includes:

Step S405: live broadcast reservation information is obtained, and the live broadcast reservation information characterizes the number of clients of audiences which obtains the viewing permission for the target live stream room.

Step S406: server resources and/or network resources of the target live stream room are determined according to the live broadcast reservation information.

Exemplarily, the live broadcast reservation information characterizes the number of clients of audiences which obtains the viewing permission for the target live stream room, specifically, for example, the number of virtual tickets sold for the target live stream room. Unlike common subscription and reservation, in a paid live broadcast scenario, if the client of an audience transfers resources (namely, purchases a virtual ticket by means of payment), the client of an audience is more likely to watch the live broadcast after the target live stream room is started to broadcast. Therefore, through the live broadcast reservation information, the access amount of the clients of audiences when the target live stream room is started to broadcast can be accurately determined, and then the server automatically allocates corresponding server resources and network resources according to the access amount, to match the access traffic of the target live stream room, thereby ensuring that the server resources are matched and the network resources are sufficient when the target live stream room is started to broadcast, and thereby improving the overall efficiency of utilization of the platform resources.

Corresponding to the method for creating a target live stream room in the above embodiments, FIG. 11 is a structural block diagram of an apparatus for creating a target live broadcast center applied to a client of a streamer according to an embodiment of the present disclosure. For ease of description, only parts related to the embodiments of the present disclosure are shown. Referring to FIG. 11, the apparatus for creating a target live stream room 5 includes:
a displaying module 51 configured to display, in response to a first input operation, a first configuration page corresponding to a first streamer identifier;
a processing module 52 configured to obtain, in response to a second input operation for the first configuration page, a live stream parameter, wherein the live stream parameter comprises a resource parameter, and the resource parameter characterizes a resource required to be transferred for obtaining a viewing permission for the target live stream room;
a receiving and transmitting module 53 configured to transmit a creation request to a server based on the live stream parameter, such that the server creates a target live stream room corresponding to the first streamer identifier, wherein the target live stream room is configured to open to a client of an audience which obtains the viewing permission for the target live stream room; and the viewing permission for the target live stream room is obtained after the client of an audience performs resource transfer based on the resource parameter of the target live stream room.

In one embodiment of the present disclosure, the live stream parameter further includes a time parameter, wherein the time parameter characterizes live broadcast time of the target live stream room; and the target live stream room is open to the client of an audience which obtains the viewing permission of the target live stream room within the live broadcast time.

In an embodiment of the present disclosure, the displaying module 51 is further configured to display, in response to a third input operation, a second configuration page corresponding to the first streamer identifier, the second configuration page including information of a stream to be started information, and the information of a stream to be started information characterizing the target live stream room already created at the server.

In an embodiment of the present disclosure, a start-to-broadcast controls are provided within the second configuration page, wherein the start-to-broadcast controls corresponds one-to-one to target live stream rooms characterized by the start-to-broadcast information, and the start-to-broadcast control is configured to immediately start a corresponding target live stream room.

In one embodiment of the present disclosure, the live stream parameter includes a time parameter, and the time parameter is configured for characterizing live broadcast time of the target live stream room; the processing module 52 is further configured to set the start-to-broadcast control to be in an available state or an unavailable state, according to current time and the time parameter corresponding to the target live stream room.

In an embodiment of the present disclosure, the displaying module 51 is further configured to display or modify a live stream parameter of a target live stream room corresponding to the information of a stream to be started information in response to the fourth input operation; or in response to a fourth input operation, delete the information of a stream to be started information, and transmit a deletion request to the server so as to transmit notification information to the client of an audience which obtains the viewing permission via the server, the deletion request being configured for deleting the target live stream room created by the server.

In one embodiment of the present disclosure, the displaying module 51 is further configured to: in response to a fifth input operation, display a third configuration page, the third configuration page including to-be-promoted information, and the to-be-promoted information characterizing a live stream room allowed to be promoted; and the processing module 52 is further configured to determine a live stream room to be promoted based on a selection operation for the to-be-promoted information, and configure a promotion link of the live stream room to be promoted in a live broadcast interface or a short video, wherein the promotion link contains association information of the first streamer identifier.

In an embodiment of the present disclosure, trigger controls are provided within the third configuration page, wherein the trigger controls correspond one-to-one to the live stream rooms characterized by the to-be-promoted information, and the trigger control is configured for generating the promotion link containing the association information of the first streamer identifier.

The displaying module 51, the processing module 52, and the transmitting and receiving module 53 are connected in sequence. The apparatus for creating a target live stream room 5 provided in this embodiment can implement the technical solutions of the foregoing method embodiments. The implementation principles and technical effects are similar, and are not repeatedly described herein in this embodiment.

Corresponding to the method for creating a target live stream room in the above embodiments, FIG. 12 is a structural block diagram of an apparatus for creating a target live stream room applied to a server according to an embodiment of the present disclosure. For ease of description, only parts related to the embodiments of the present disclosure are shown. Referring to FIG. 12, the apparatus for creating a target live stream room 6 includes:
a transmitting and receiving module 61 configured to receive a creation request transmitted by a client of a streamer, and obtain a live stream parameter based on the creation request, wherein the live stream parameter comprises a resource parameter, and the resource parameter characterizes a resource required to be transferred for obtaining a viewing permission for the target live stream room;
a creating module 62 configured to create, based on the live stream parameter, a target live stream room corresponding to a first streamer identifier at the server, the target live stream room being configured to open to a client of an audience which obtains the viewing permission for the target live stream room, and the viewing permission for the target live stream room being obtained after the client of an audience performs resource transfer based on the resource parameter of the target live stream room.

In one embodiment of the present disclosure, the transmitting and receiving module 61 is further configured to: receive a viewing request transmitted by a client of an audience, and determine, based on the viewing request, whether the client of an audience has obtained the viewing permission; and in response to that the client of an audience has obtained the viewing permission, push live broadcast stream of the target live stream room to the client of an audience.

In one embodiment of the present disclosure, the live stream parameter further includes a time parameter, wherein the time parameter characterizes live broadcast time of the target live stream room; when pushing the live broadcast stream of the target live stream room to the client of an audience, the transmitting and receiving module 61 is specifically configured to push, in response to time corresponding to the viewing request being within the live broadcast time, the live broadcast stream of the target live stream room to the client of an audience.

In one embodiment of the present disclosure, after determining that the client of an audience has obtained the viewing permission, the transmitting and receiving module 61 is further configured to encrypt, based on the viewing request transmitted by the client of an audience, the live broadcast stream of the target live stream room to obtain the encrypted live broadcast stream, wherein decryption information of the encrypted live broadcast stream corresponds one-to-one to clients of audiences; when pushing the live broadcast stream of the target live stream room to the client of an audience, the transmitting and receiving module 61 is specifically configured to push the encrypted live broadcast stream to the client of an audience.

In one embodiment of the present disclosure, the creating module 62 is further configured to obtain live broadcast reservation information, wherein the live broadcast reservation information characterizes the number of clients of audiences which obtains the viewing permission for the target live stream room; determine server resources and/or network resources of the target live broadcast according to the predetermined live broadcast information.

The transmitting and receiving module 61 is connected to the creating module 62. The apparatus for creating target live broadcast 6 provided by this embodiment may execute the technical solution of the foregoing method embodiment. The implementation principle and technical effect are similar, and are not repeatedly described herein.

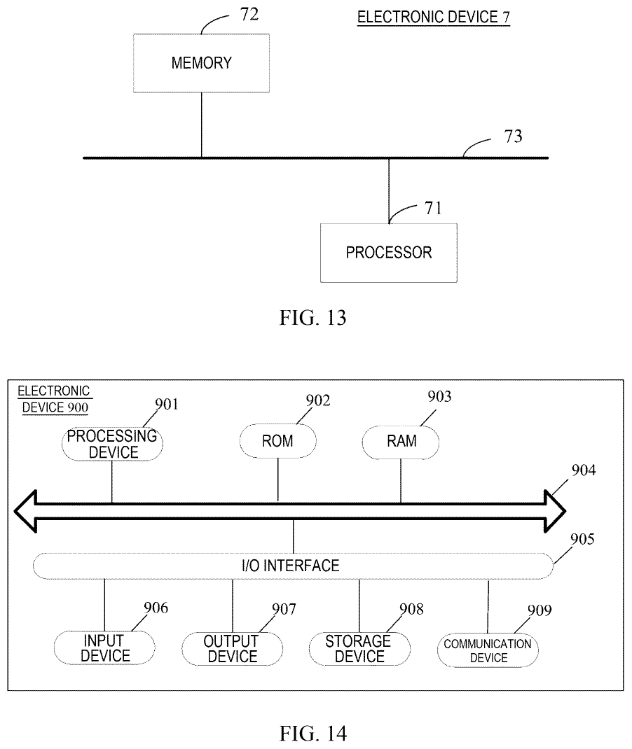

FIG. 13 is a schematic structural diagram of an electronic device according to an embodiment of the present disclosure. As shown in FIG. 13, the electronic device 7 includes:
a processor 71, and a memory 72 communicatively connected with the processor 71;
the memory 72 stores a computer execution instruction;
the processor 71 executes the computer execution instruction stored in the memory 72, so as to implement the methods in the embodiments shown in FIG. 2 to FIG. 10.

Optionally, the processor 71 and the memory 72 are connected through a bus 73.

The related descriptions can be understood with reference to the related descriptions and effects corresponding to the steps in the embodiments corresponding to FIG. 2 to FIG. 10, and are not repeated herein.

Referring to FIG. 14 below, it is a structural schematic diagram of an electronic device 900 suitable for implementing the embodiment of the present disclosure. The electronic device 900 may be a terminal device or a server. The terminal device in the embodiment of the present disclosure may include but is not limited to mobile terminals such as mobile phones, laptops, digital broadcast receivers, Personal Digital Assistants (PDA for short), Portable Android Devices (PAD for short), portable multimedia players (PMP for short), car-mounted terminals (such as car navigation terminals), etc. and fixed terminals such as digital televisions (TV), desktop computers, etc. The electronic device shown in FIG. 14 is only an example and should not bring any limitation on the functionality and scope of use of the embodiment of the present disclosure.

As shown in FIG. 14, the electronic device 900 may include a processing device (such as a central processing unit, graphics processing unit, etc.) 901, which may perform various appropriate actions and processes based on programs stored in Read-Only Memory (ROM for short) 902 or loaded from storage device 908 into Random Access Memory (RAM for short) 903. In the RAM 903, various programs and data necessary for the operation of the electronic device 900 are also stored. The processing device 901, ROM 902, and RAM 903 are connected to each other through a bus 904. An Input/Output I/O interface 905 is also connected to the bus 904.

Typically, the following devices can be connected to I/O interface 905: input devices 906 including, for example, touch screens, touchpads, keyboards, mice, cameras, microphones, accelerometers, gyroscopes, etc.; output devices 907 including liquid crystal displays (LCD for short), speakers, vibrators, etc.; storage devices 908 including magnetic tapes, hard disks, etc.; and a communication device 909. The communication device 909 may allow the electronic device 900 to communicate with other devices wirelessly or wirelessly to exchange data. Although FIG. 14 shows an electronic device 900 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 909, or installed from the storage device 908, or installed from the ROM 902. When the computer program is executed by the processing device 901, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device implements the method as described in the above embodiments.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN for short) or wide area network (WAN for short)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

In a first aspect, according to one or more embodiments of the present disclosure, a method for creating a target live broadcast center is provided, which is applied to a client of a streamer, the method includes:

in response to a first input operation, displaying a first configuration page corresponding to a first streamer identifier; in response to a second input operation for the first configuration page, obtaining a live stream parameter, wherein the live stream parameter comprises a resource parameter; and transmitting a creation request to a server based on the live stream parameter, such that the server creates a target live stream room corresponding to the first streamer identifier; wherein the resource parameter characterizes a resource required to be transferred for obtaining a viewing permission for the target live stream room, and the target live stream room is configured to open to a client of an audience which obtains the viewing permission for the target live stream room, wherein the viewing permission for the target live stream room is obtained after the client of an audience performs resource transfer based on the resource parameter of the target live stream room.

According to one or more embodiments of the present disclosure, the live stream parameter further includes a time parameter, and the time parameter characterizes live broadcast time of the target live stream room; and the target live stream room is open to the client of an audience which obtains the viewing permission of the target live stream room within the live broadcast time.

According to one or more embodiments of the present disclosure, the method further includes: in response to a third input operation, displaying a second configuration page corresponding to the first streamer identifier, the second configuration page including information of a stream to be started information, and the information of a stream to be started information characterizing the target live stream room already created at the server.

According to one or more embodiments of the present disclosure, start-to-broadcast controls are provided within the second configuration page, wherein the start-to-broadcast controls corresponds one-to-one to target live stream rooms characterized by the start-to-broadcast information, and the start-to-broadcast control is configured to immediately start a corresponding target live stream room.

According to one or more embodiments of the present disclosure, the live stream parameter includes a time parameter, and the time parameter is configured for characterizing live broadcast time of the target live stream room; the method further includes: setting the start-to-broadcast control to be in an available state or an unavailable state, according to current time and the time parameter corresponding to the target live stream room.

According to one or more embodiments of the present disclosure, the method further includes: in response to a fourth input operation, displaying or modifying a live stream parameter of a target live stream room corresponding to the information of a stream to be started information; or in response to a fourth input operation, deleting the information of a stream to be started information, and transmitting a deletion request to the server so as to transmit notification information to the client of an audience which obtains the viewing permission via the server, the deletion request being configured for deleting the target live stream room created by the server.

According to one or more embodiments of the present disclosure, the method further includes: in response to a fifth input operation, displaying a third configuration page, the third configuration page comprising to-be-promoted information, and the to-be-promoted information characterizing a live stream room allowed to be promoted; and determining a live stream room to be promoted based on a selection operation for the to-be-promoted information, and configuring a promotion link of the live stream room to be promoted in a live broadcast interface or a short video, wherein the promotion link contains association information of the first streamer identifier.

According to one or more embodiments of the present disclosure, trigger controls are provided within the third configuration page, wherein the trigger controls correspond one-to-one to the live stream rooms characterized by the to-be-promoted information, and the trigger control is configured for generating the promotion link containing the association information of the first streamer identifier.

In a second aspect, according to one or more embodiments of the present disclosure, a method for creating a target live stream room is provided, which is applied to a server. The method includes:

receiving a creation request transmitted by a client of a streamer, and obtaining a live stream parameter based on the creation request, wherein the live stream parameter includes a resource parameter, and the resource parameter characterizes a resource required to be transferred for obtaining a viewing permission for the target live stream room; and creating, based on the live stream parameter, a target live stream room corresponding to a first streamer identifier at the server, wherein the target live stream room is configured to open to a client of an audience which obtains the viewing permission for the target live stream room; and the viewing permission for the target live stream room is obtained after the client of an audience performs resource transfer based on the resource parameter of the target live stream room.

According to one or more embodiments of the present disclosure, the method further includes: receiving a viewing request transmitted by a client of an audience, and determining, based on the viewing request, whether the client of an audience has obtained the viewing permission; and in response to that the client of an audience has obtained the viewing permission, pushing live broadcast stream of the target live stream room to the client of an audience.

According to one or more embodiments of the present disclosure, the live stream parameter further includes a time parameter, and the time parameter characterizes live broadcast time of the target live stream room; pushing the live broadcast stream of the target live stream room to the client of an audience includes: in response to time corresponding to the viewing request being within the live broadcast time, pushing the live broadcast stream of the target live stream room to the client of an audience.

According to one or more embodiments of the present disclosure, the method further includes, after determining that the client of an audience has obtained the viewing permission: encrypting, based on the viewing request transmitted by the client of an audience, the live broadcast stream of the target live stream room to obtain the encrypted live broadcast stream, wherein decryption information of the encrypted live broadcast stream corresponds one-to-one to clients of audiences; pushing the live broadcast stream of the target live stream room to the client of an audience includes: pushing the encrypted live broadcast stream to the client of an audience.

According to one or more embodiments of the present disclosure, the method further includes: obtaining live broadcast reservation information, wherein the live broadcast reservation information characterizes the number of clients of audiences which obtains the viewing permission for the target live stream room; and determining server resources and/or network resources of the target live stream room according to the live broadcast reservation information.

In a third aspect, according to one or more embodiments of the present disclosure, an apparatus for creating a target live stream room is provided, which is applied to a client of a streamer, the apparatus includes:
a displaying module configured to display, in response to a first input operation, a first configuration page corresponding to a first streamer identifier;
a processing module configured to obtain, in response to a second input operation for the first configuration page, a live stream parameter, wherein the live stream parameter comprises a resource parameter, and the resource parameter characterizes a resource required to be transferred for obtaining a viewing permission for the target live stream room; and
a transmitting and receiving module configured to transmit a creation request to a server based on the live stream parameter, such that the server creates a target live stream room corresponding to the first streamer identifier, wherein the target live stream room is configured to open to a client of an audience which obtains the viewing permission for the target live stream room, and the viewing permission for the target live stream room is obtained after the client of an audience performs resource transfer based on the resource parameter of the target live stream room.

According to one or more embodiments of the present disclosure, the live stream parameter further includes a time parameter and the time parameter characterizes live broadcast time of the target live stream room; and the target live stream room is open to the client of an audience which obtains the viewing permission of the target live stream room within the live broadcast time.

According to one or more embodiments of the present disclosure, the display module is further configured to display, in response to a third input operation, a second configuration page corresponding to the first streamer identifier, the second configuration page including information of a stream to be started information, and the information of a stream to be started information characterizing the target live stream room already created at the server.

According to one or more embodiments of the present disclosure, start-to-broadcast controls are provided within the second configuration page, wherein the start-to-broadcast controls corresponds one-to-one to target live stream rooms characterized by the start-to-broadcast information, and the start-to-broadcast control is configured to immediately start a corresponding target live stream room.

According to one or more embodiments of the present disclosure, the live stream parameter includes a time parameter, and the time parameter is configured for characterizing live broadcast time of the target live stream room; the processing module is further configured to set the start-to-broadcast control to be in an available state or an unavailable state, according to current time and the time parameter corresponding to the target live stream room.

According to one or more embodiments of the present disclosure, the display module is further configured to display or modify t a live stream parameter of a target live stream room corresponding to the information of a stream to be started information in response to a fourth input operation; or in response to a fourth input operation, delete the information of a stream to be started information, and transmit a deletion request to the server so as to transmit notification information to the client of an audience which obtains the viewing permission via the server, the deletion request being configured for deleting the target live stream room created by the server.

According to one or more embodiments of the present disclosure, the display module is further configured to display a third configuration page in response to a fifth input operation, wherein the third configuration page including to-be-promoted information, and the to-be-promoted information characterizing a live stream room allowed to be promoted by the client of a streamer corresponding to the first streamer identifier; the processing module 52 is further configured to determine a live stream room to be promoted based on a selection operation for the to-be-promoted information, and configure a promotion link of the live stream room to be promoted in a live broadcast interface or a short video, wherein the promotion link contains association information of the first streamer identifier.

According to one or more embodiments of the present disclosure, trigger controls are provided within the third configuration page, wherein the trigger controls correspond one-to-one to the live stream rooms characterized by the to-be-promoted information, and the trigger control is configured for generating the promotion link containing the association information of the first streamer identifier.

In a fourth aspect, according to one or more embodiments of the present disclosure, an apparatus for creating a target live stream room is provided, which is applied to a server. The apparatus includes:
a transmitting and receiving module configured to receive a creation request transmitted by a client of a streamer, and obtain a live stream parameter based on the creation request, wherein the live stream parameter comprises a resource parameter, and the resource parameter characterizes a resource required to be transferred for obtaining a viewing permission for the target live stream room; and
a creating module configured to create, based on the live stream parameter, a target live stream room corresponding to a first streamer identifier at the server, the target live stream room being configured to open to a client of an audience which obtains the viewing permission for the target live stream room.

According to one or more embodiments of the present disclosure, the transmitting and receiving module is further configured to receive a viewing request transmitted by a client of an audience, and determine, based on the viewing request, whether the client of an audience has obtained the viewing permission; and in response to that the client of an audience has obtained the viewing permission, push live broadcast stream of the target live stream room to the client of an audience.

According to one or more embodiments of the present disclosure, the live stream parameter further includes a time parameter, wherein the time parameter characterizes live broadcast time of the target live stream room; when pushing the live broadcast stream of the target live stream room to the client of an audience, the transmitting and receiving module is specifically configured to push, in response to time corresponding to the viewing request being within the live broadcast time, the live broadcast stream of the target live stream room to the client of an audience.

According to one or more embodiments of the present disclosure, after determining that the client of an audience has obtained the viewing permission, the transmitting and receiving module is further configured to encrypt, based on the viewing request transmitted by the client of an audience, the live broadcast stream of the target live stream room to obtain the encrypted live broadcast stream, wherein decryption information of the encrypted live broadcast stream corresponds one-to-one to clients of audiences; when pushing the live broadcast stream of the target live stream room to the client of an audience, the transmitting and receiving module is specifically configured to push the encrypted live broadcast stream to the client of an audience.

According to one or more embodiments of the present disclosure, the creating module is further configured to: obtain live broadcast reservation information, wherein the live broadcast reservation information characterizes the number of clients of audiences which obtains the viewing permission for the target live stream room; and determine server resources and/or network resources of the target live stream room according to the live broadcast reservation information.

In a fifth aspect, according to one or more embodiments of the present disclosure, an electronic device is provided, which includes:
a processor and a memory communicatively connected to the processor;
the memory stores a computer execution instruction;
the processor executes the computer execution instruction stored in the memory, to implement the method for creating a target live stream room according to the first aspect and various possible designs of the first aspect, or implement the method for creating a target live stream room according to the second aspect and the various possible designs of the second aspect.

In a sixth aspect, according to one or more embodiments of the present disclosure, a computer readable storage medium is provided. The computer readable storage medium stores a computer execution instruction, and when executing the computer execution instruction, a processor implements the method for creating a target live stream room according to the first aspect and various possible designs of the first aspect, or, implements the method for creating a target live stream room according to the second aspect and various possible designs of the second aspect.

In a seventh aspect, according to one or more embodiments of the present disclosure, a computer program product is provided, which includes a computer program. When being executed by a processor, the computer program implements the method for creating a target live stream room according to the first aspect and various possible designs of the first aspect, or implements the method for creating a target live stream room according to the second aspect and various possible designs of the second aspect.

In an eighth aspect, according to one or more embodiments of the present disclosure, a computer program is provided. When being executed by a processor, the computer program implements the method for creating a target live stream room according to the first aspect and various possible designs of the first aspect, or implements the method for creating a target live stream room according to the second aspect and various possible designs of the second aspect.

In the method and apparatus for creating a target live stream room, the electronic device and the storage medium provided by the present embodiment, in response to a first input operation, a first configuration page corresponding to a first streamer identifier is displayed; in response to a second input operation for the first configuration page, a live stream parameter is obtained, wherein the live stream parameter includes a resource parameter, the resource parameter characterizes a resource required to be transferred for obtaining a viewing permission for the target live stream room; and a creation request is transmitted to a server based on the live stream parameter, such that the server creates a target live stream room corresponding to the first streamer identifier; wherein the target live stream room is configured to open to a client of an audience which obtains the viewing permission for the target live stream room, and the viewing permission for the target live stream room is obtained after the client of an audience performs resource transfer based on the resource parameter of the target live stream room. In this way, the streamer user can autonomously create a charging live stream room at the client of a streamer, thereby simplifying the creation flow for the paid live stream room. In this way, the establishment efficiency of the charging live broadcast is improved.

The above description is only embodiments of this disclosure, and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

What is claimed is:

1. A method for creating a target live stream room applying to a client of a streamer, wherein, the method comprises:
in response to a first input operation, displaying a first configuration page corresponding to a first streamer identifier;
in response to a second input operation for the first configuration page, obtaining a live stream parameter, wherein the live stream parameter comprises a resource parameter; and
transmitting a creation request to a server based on the live stream parameter, such that the server creates a target live stream room corresponding to the first streamer identifier; wherein the resource parameter indicates a resource required to be transferred for obtaining a viewing permission for the target live stream room, and the target live stream room is available to a client of an audience which obtains the viewing permission for the target live stream room.

2. The method of claim 1, wherein the viewing permission for the target live stream room is obtained after the client of an audience performs resource transfer based on the resource parameter of the target live stream room.

3. The method of claim 1, wherein the live stream parameter further comprises a time parameter, and the time parameter indicates live stream time of the target live stream room; and
the target live stream room is available to the client of an audience which obtains the viewing permission for the target live stream room within the live stream time.

4. The method of claim 1, wherein the method further comprises:
in response to a third input operation, displaying a second configuration page corresponding to the first streamer identifier, the second configuration page comprising information of a stream to be started, and the information of a stream to be started indicating the target live stream room already created at the server.

5. The method of claim 4, wherein start-to-stream controls are provided within the second configuration page, wherein the start-to-stream controls corresponds one-to-one to target live stream rooms indicated by the information of a stream to be started, and the start-to-stream control is configured to immediately start a corresponding target live stream room.

6. The method of claim 5, wherein the live stream parameter comprises a time parameter, and the time parameter is configured for indicating live stream time of the target live stream room;
the method further comprises:
setting the start-to-stream control to be in an available state or an unavailable state, according to current time and the time parameter corresponding to the target live stream room.

7. The method of claim 4, wherein the method further comprises:
in response to a fourth input operation, displaying or modifying a live stream parameter of a target live stream room corresponding to the information of a stream to be started; or,
in response to a fourth input operation, deleting the information of a stream to be started, and transmitting a deletion request to the server so as to transmit, via the server, notification information to the client of an audience obtains the viewing permission, the deletion request being configured for deleting the target live stream room created by the server.

8. The method of claim 1 wherein the method further comprises:
in response to a fifth input operation, displaying a third configuration page, the third configuration page comprising to-be-promoted information, and the to-be-promoted information indicating a live stream room allowed to be promoted; and
determining a live stream room to be promoted based on a selection operation for the to-be-promoted information, and configuring a promotion link of the live stream room to be promoted in a live stream interface or a short video, wherein the promotion link contains association information of the first streamer identifier.

9. The method of claim 8, wherein trigger controls are provided within the third configuration page, wherein the trigger controls correspond one-to-one to the live stream rooms indicated by the to-be-promoted information, and the trigger control is configured for generating the promotion link containing the association information of the first streamer identifier.

10. A method for creating a target live stream room applying to a server, wherein, the method comprises:
receiving a creation request transmitted by a client of a streamer, and obtaining a live stream parameter based on the creation request, wherein the live stream parameter comprises a resource parameter; and
creating, based on the live stream parameter, a target live stream room corresponding to a first streamer identifier at the server, wherein the resource parameter indicates a resource required to be transferred for obtaining a viewing permission for the target live stream room, and the target live stream room is available to a client of an audience which obtains the viewing permission for the target live stream room.

11. The method of claim 10, wherein the viewing permission for the target live stream room is obtained after the client of an audience performs a resource transfer based on the resource parameter of the target live stream room.

12. The method of claim 10, wherein the method further comprises:
receiving a viewing request transmitted by a client of an audience, and determining, based on the viewing request, whether the client of an audience has obtained the viewing permission; and
in response to that the client of an audience has obtained the viewing permission, pushing a live broadcast stream of the target live stream room to the client of an audience.

13. The method of claim 12, wherein the live stream parameter further comprises a time parameter, and the time parameter indicates live stream time of the target live stream room;
pushing the live broadcast stream of the target live stream room to the client of an audience comprises:
in response to time corresponding to the viewing request being within the live stream time, pushing the live broadcast stream of the target live stream room to the client of an audience.

14. The method of claim 12, wherein the method further comprises, after determining that the client of an audience has obtained the viewing permission:
encrypting, based on the viewing request transmitted by the client of an audience, the live broadcast stream of the target live stream room to obtain an encrypted live broadcast stream, wherein decryption information of the encrypted live broadcast stream corresponds one-to-one to clients of audiences;
pushing the live broadcast stream of the target live stream room to the client of an audience comprises:
pushing the encrypted live broadcast stream to the client of an audience.

15. The method of claim 10, wherein the method further comprises:
obtaining live stream reservation information, wherein the live stream reservation information indicating a number of clients of audiences which obtains the viewing permission for the target live stream room; and
determining server resources and/or network resources of the target live stream room according to the live stream reservation information.

16-21. (canceled)

22. An electronic device, wherein the electronic device comprises a processor and a memory communicatively connected to the processor;
the memory stores a computer execution instruction;
the processor executes the computer execution instruction stored in the memory to implement the method for creating a target live stream room comprising:
in response to a first input operation, displaying a first configuration page corresponding to a first streamer identifier;
in response to a second input operation for the first configuration page, obtaining a live stream parameter, wherein the live stream parameter comprises a resource parameter; and
transmitting a creation request to a server based on the live stream parameter, such that the server creates a target live stream room corresponding to the first streamer identifier; wherein the resource parameter indicates a resource required to be transferred for obtaining a viewing permission for the target live stream room, and the target live stream room is available to a client of an audience which obtains the viewing permission for the target live stream room.

23. The electronic device of claim 22, wherein the viewing permission for the target live stream room is obtained after the client of an audience performs resource transfer based on the resource parameter of the target live stream room.

24. The electronic device of claim 22, wherein the live stream parameter further comprises a time parameter, and the time parameter indicates live stream time of the target live stream room; and
the target live stream room is available to the client of an audience which obtains the viewing permission for the target live stream room within the live stream time.

25. The electronic device of claim 22, wherein the method further comprises:
in response to a third input operation, displaying a second configuration page corresponding to the first streamer identifier, the second configuration page comprising information of a stream to be started, and the information of a stream to be started indicating the target live stream room already created at the server.
